(19) United States
(12) Patent Application Publication
(10) Pub. No.: US 2017/0354018 A1
(43) Pub. Date: Dec. 7, 2017

(54) GPS-BASED LIGHTING CONTROL SYSTEM

(71) Applicant: GE LIGHTING SOLUTIONS LLC, Cleveland, OH (US)

(72) Inventors: Glenn Howard Kuenzler, Beachwood, OH (US); Tomislav Stimac, Concord, OH (US); Mark Mayer, Sagamore Hills, OH (US)

(21) Appl. No.: 15/643,986

(22) Filed: Jul. 7, 2017

Related U.S. Application Data
(63) Continuation-in-part of application No. 12/906,384, filed on Nov. 19, 2010, now abandoned.

(51) Int. Cl. H05B 37/02; H04W 4/02; G08G 1/095; H05B 33/08; G08B 29/02

(52) U.S. Cl. CPC H05B 37/0227; H05B 37/0245; H05B 33/089; G08B 29/02; G08G 1/095; H04W 4/02

(57) ABSTRACT

A GPS-based lighting system is provided that includes at least one lighting fixture including a light source and a GPS microchip incorporated therein and a control capable of broadcasting a signal comprising instructions to the at least one lighting fixture according to the location of the lighting fixture as determined by the GPS microchip.

### BACKGROUND

This application is a continuation-in-part of U.S. Ser. No. 12/906,384 filed Nov. 19, 2010. U.S. Ser. No. 12/906,384 filed Nov. 19, 2010 is incorporated herein by reference in its entirety

The following relates to lighting systems and devices, and particularly to lighting systems and devices integrated with GPS technology.

Various systems have been used to control the functioning of lighting units. U.S. 2007/0029949 describes systems that incorporate a motion detector or sensor, wherein lights turn on, off, or are dimmed according to a detected level of motion within the room. U.S. Pat. No. 7,019,276 discloses a system that incorporates a scheduler, which includes a real-time clock to coordinate at what time lights must be turned on and/or off, and also systems that include light sensors for providing a measurement of the overall light level in a particular area, which is then compared to a light level set point. Although such systems are generally effective, such sensors and clocks are prone to errors and variability, which can affect the overall efficiency of the system. Particularly in the context of outdoor LEDs, if used during the day, the LEDs can get overheated by the sunlight, which could cause the entire fixture to break. Additionally, such systems cannot control lighting function outside detected movement and sunlight, and are therefore of limited utility.

Positional systems have recently been incorporated into various devices to assist in controlling lighting mechanics, such as a mobile phone backlight and vehicle lighting systems. A real-time positional system, Global Positioning Systems (GPS), is widely used as a space-based global navigation system that provides reliable location and time information in all weather and at all times anywhere on earth. GPS comprises three segments: a space segment comprising 24 operating satellites that transmit one-way signals, a control segment that consists of worldwide monitor and control stations that maintain the satellites in their proper orbits through occasional command maneuvers, and a user segment that consists of the GPS receiver, which receives the signals from the GPS satellites and uses the transmitted information to calculate a user's three dimensional position and time.

JP Patent Laid-Open No. 2-296550 illustrates one example of the implantation of GPS in vehicles to control light distribution, wherein the distribution of light according to a road shape is based on information from a navigation apparatus. U.S. 2006/0172745 describes the incorporation of GPS in non-automotive fields, such as in a mobile electronic device, wherein the GPS controls the display backlight based on positional data.

Recently, GPS has been implemented into general lighting systems as a way of controlling lighting functions. For instance, U.S. 20070091623 discloses a plurality of luminaire managers that monitor the status of their respective luminaries and may include a GPS for locating the position of a luminaire manager. Additionally, the GPS is used to determine if coordinates differ from what is expected to detect is a luminaire was installed improperly or has been removed. Finally, U.S. Pat. No. 7,659,676 provides a lighting system that implements a GPS receiver for calculating sunrise and sunset times and providing such information to a controller that turns a light on and off according to such times. However, there remains a need for an improved light management system that is able to control one or more lighting fixtures based solely on geographical location, independent of sunrise and sunset times.

### BRIEF SUMMARY

According to one aspect, a GPS-based lighting system is provided. The GPS-based lighting system includes at least one lighting fixture including a light source and a GPS microchip incorporated therein, and a control capable of broadcasting a general signal transmitting instructions to the lighting fixture according to the location of the lighting fixture determined by the GPS microchip.

According to another aspect, a method of controlling the operation of lighting fixtures is provided. The method includes providing at least one lighting fixture including a light source and a GPS microchip, transmitting the GPS coordinate zone to a control system, broadcasting a signal from the control system to the lighting fixture specifying at least one coordinate zone, receiving said signal by said at least one lighting fixture. The GPS microchip provides the at least one lighting fixture with its precise GPS coordinate zone.

According to yet another aspect, a method of geographically controlling a plurality of lighting fixtures is provided. The method includes providing each of the plurality of lighting fixtures with a light source and a GPS microchip, identifying the geographic coordinate location of the lighting fixture based on information provided by the GPS microchip, transmitting the geographic coordinate location from the GPS microchip to a lighting control system, providing the lighting control system with operating instructions specific to particular geographic coordinate location, and broadcasting a signal, including the operating instructions, to each of said plurality of lighting fixtures, Only the lighting fixtures possessing the particular geographic coordinates carry out the operating instructions.

### BRIEF DESCRIPTION OF THE DRAWINGS

The invention may take form in various components and arrangements of components, and in various process operations and arrangements of process operations. The drawing is only for purposes of illustrating embodiments and is not to be construed as limiting the invention.

FIG. 1 illustrates an exemplary method of using the GPS lighting system of the present disclosure to guide traffic in a parking lot.

### DETAILED DESCRIPTION OF PREFERRED EMBODIMENTS

A lighting system is provided that includes at least one lighting fixture with a light source. The lighting fixtures described herein may be outdoor lighting fixtures such as, for example, a lamp post, lantern, street light, flood light, beacon lights, security lights, entry lights, accent lights, and the like. Although this application will be described generally in terms of street lighting, it should be appreciated that the lighting systems contemplated herein may be implemented into various types of indoor and outdoor lighting fixtures alike. Generally, a street light is a raised light source at the edge of a road or parking lot that is primarily used to light dark areas to prevent accidents and increase safety. However, street lights may additionally be used for non-traditional purposes, such as to create a path, provide parking guidance, indicate an emergency or severe weather, or to mark a location.

According to one aspect of the present disclosure, a lighting system incorporates Global Positions System (GPS) technology into the local electronics of the lighting fixtures. The lighting system further includes lighting controls to enable both remote and automated adjustment and control of the lighting fixtures, which may be separate from or integrated into the lighting fixture. Although the application describes the positional system in terms of GPS, other positional systems may be implemented such as, for example, MLS (Microwave Landing Systems, GSM (Global System Mobile), GIS (Geographical Information Systems, and CPS (Cambridge Positioning Systems).

The lighting control is implemented for broadcasting instructions to either a single light fixture, or a plurality of grouped or otherwise associated light fixtures. The implementation of a GPS microchip in a lighting fixture allows the fixture to, in a sense, know its location, and broadcast this location to the lighting control, which would then allow for strategic and specific control of the light fixture from any location. For example, a lighting control can broadcast instructions to all fixtures capable of receiving the signal and only the fixtures included in a specific GPS coordinate zone would carry out the transmitted instructions. The broadcast signal can instruct the fixtures to turn on, turn off, dim, flash, change color, etc., depending on the desired lighting purpose.

According to one embodiment, the GPS also provides the fixture with internal knowledge of the local sunrise and sunset times, such that it could be programmed to turn on and off intelligently without a daytime sensor that could be prone to errors and variability. Compared to local clocks and light sensors, the GPS allows for additional flexibility of lighting control design and reduces control dependency. The GPS creates “smart” fixtures that can gain knowledge about their surroundings and enable a wide network lighting control system, since the fixture listens when a broadcast is transmitted and reacts only to the instructions that apply to its specific or general coordinate location.

The lighting system contemplated herein provides the benefit that the signals broadcasted from the lighting controls do not need to be specifically dedicated to a particular lighting fixture, and can rather be generally broadcasted to all light fixtures that are designed to accept such a signal. However, only the particular fixtures that meet the coordinate criteria will respond to the signal and those that do not will remain unaffected. For example, parking lots may include perimeter lights that are only required to be on during special events. The GPS-based lighting system will transmit a signal to all light fixtures that can pick up such a signal, and only those specific lights within a specified GPS zone will respond to the signal and be activated.

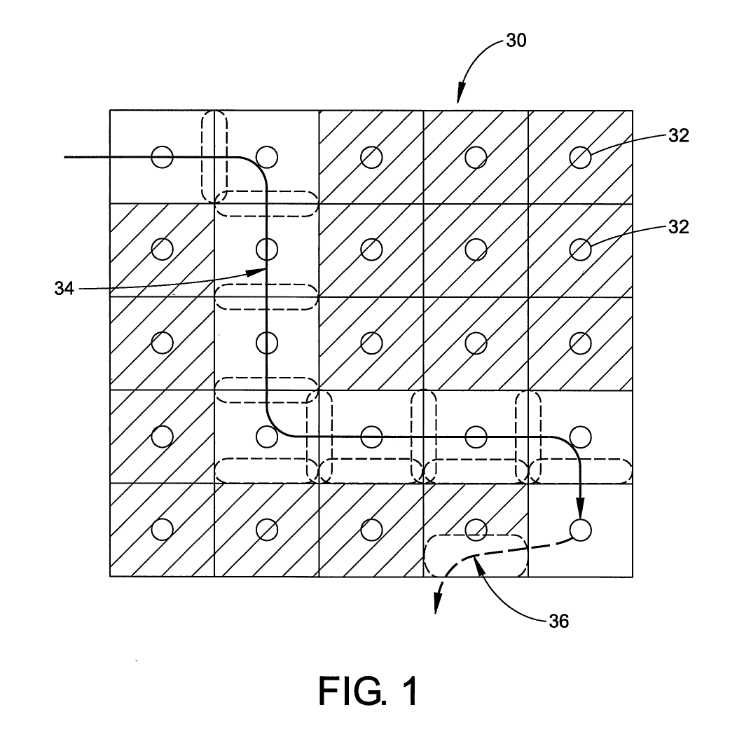

According to another aspect best illustrated in FIG. 1, a parking lot 10 may include many different phases, such as the back, the middle, and the front of the parking lot, and it might be preferred to fill the phases according to a location preference or in a particular order. The GPS-based lighting system can transmit a signal instructing only the light fixtures 12 in certain phases of the parking lot 10 to turn on and guide visitors to a desired parking area. As the parking lot fills, the activated lighting shifts to guide visitors into different parking phases. Such shifting can occur by dimming the lights in areas that are full and brightening area that remain available for parking, although other designations such as changing colors, etc. are also contemplated. Areas in which parking is to be avoided may be left dark. The lights can additionally be instructed to illuminate a path 14 to guide visitors to an available parking spot. The lighting system may signal when and where a visitor is to turn based on distinguishing feature, such as brightness, color, flashes, etc. Once the vehicle is parked, the lights along a pathway to a visitor's destination may be strategically illuminated to ensure a visitor 1) can easily find the way to a destination, and 2) reach the destination safely and comfortably.

The lighting control system can be configured to perform wireless firmware updating of at least one or more lighting fixture. More particularly, over time it is often desirable to update one or all of the memory, code or data stored in the computing hardware (microprocessor) of the lighting fixture. This type of activity can be generally referred to as commissioning. For example, it is often desirable to upgrade the code or fix programming bugs. Similarly, it is often desirable to update the stored data or operating instructions for the lighting fixture. It can be advantageous to perform this upgrading/updating remotely using the geographic location of the lighting fixture. Moreover, it is possible that upgrading/updating will be performed differently for each fixture based on its geographic location. Similarly, based on the date of installation or last upgrade/update, each fixture may require different treatment.

The GPS based lighting system of the present disclosure is advantageous because the system is configured to notify maintenance personal, via communication with the lighting control system, of fixture status. This notification can include providing periodic operational reports to maintenance personnel and/or immediate notification of an undesirable change in status in one or more fixtures.

In view of the inclusion of the GPS locating chip and the fixtures ability to broadcast, the automated lighting control system can be continuously or intermittently advised of each particular fixtures' status. Based on the GPS location, the lighting control system can know what fixture is being monitored. The present GPS system can assign an “address” to each lighting fixture based on geographic location which can be performed independently or in cooperation with a media access control address (MAC address).

The ability to use GPS based addressing allows “plug and play” auto-commissioning of each individual fixture. Moreover, once a fixture is powered, it's microchip can communicate with the lighting control system, advising the lighting control system that the fixture is on-line and providing a GPS location. Thereafter, the fixture can receive location specific instructions from the lighting control system. This is advantageous relative to MAC address systems which must be manually entered into a lighting control system database, which is a time consuming and error prone process.

In addition, the use of GPS location rather than MAC address, allows the lighting control system to instruct a fixture based on a desired lighting outcome, rather than a perceived fixture location. In this regard, basing lighting instructions from the lighting control system on GPS location achieves lighting precise location desired, rather than in a perceived location based on a stored database of MAC addresses. Similarly, fixture repositioning can be performed with automated lighting control system updating, rather than manual updating of a fixture location based on the MAC address of the associated node.

In short, the present embodiment provides significantly improved asset management of a lighting system such as a community or industrial lamp distribution. Particularly, it allows automated communication of fixture status (e.g. driver, LED, etc.) with a central control system which identifies the location of the fixture by GPS location. The central control system can utilize the location of the fixture on a map to evaluate the asset and determine what corrective measures need to be deployed and in what time frame. For example, repair personnel may be deployed first to a disabled asset in a high traffic region of a relevant grid of fixtures rather than a disabled asset in a low traffic region.

Furthermore, the lighting control system can be a “smart” system capable of determining a pattern of failures that allows preventive maintenance to be dispatched. For example, the lighting control system may determine that lighting power supplies typically fail after a calculated threshold period of operation. Using GPS address, housing of operation and maintenance records, the lighting control system can dispatch preventative maintenance to make power supply replacement shortly in advance of the calculated threshold period.

The lighting control system can be configured to dispatch a maintenance vehicle in response to a fixture status showing a fault. This feature is possible by providing the lighting fixture with a sensor capable of detecting a failure mode. In certain embodiments, it may be desirable for the sensor to have the capability to determine the source of the failure. For example, if the failure is associated with the power supply, LED operation, software, etc., the lighting control system can dispatch the appropriately outfitted maintenance personnel. Moreover, the fixtures' ability to communicate the basis of the failure can expedite repair activities.

In this regard, the lighting control system can be configured to identify the fixture location on an electronic map and provide the location to a maintenance vehicle. The lighting control system can similarly provide the maintenance vehicle with a suggested route to the failed fixture. The lighting control system is also configured to provide the maintenance vehicle with a listing of recommended spare parts to carry.

Since the components and materials contained in the lighting fixture can be valuable, the GPS based lighting system can be also be configured to determine and track theft of the lighting fixture. Moreover, the component and materials contained in the lighting fixture can be valuable. Similarly, the GPS based lighting system can be configured to monitor current and prior locations of each fixture.

The lighting control system of the present disclosure advantageously performs a centralized control/management system for a remote and potentially geographical vast illumination network. It may have particular relevance for use with municipalities. For example, the system could provide centralized management/control of a city, county or state lighting system. Similarly, the system could provide benefit as used in association with an industrial complex or building. Moreover, the system can provide centralized management/control of at least one of the functions selected from firmware updating, maintenance instructions, repair vehicle or personnel dispatch, mapping of fixture location, and identification of fixture theft. These benefits are achieved by a global positioning system (GPS) based lighting system comprising a plurality of lighting fixtures, each lighting fixture including a light source, a sensor capable of detecting status of the fixture, and a microchip configured to detect and broadcast a geographic location of the lighting fixture.

According to yet another example, the GPS-based lighting system provides the ability to provide emergency lighting in times of severe weather, a traffic accident, an Amber Alert, or other such emergency situations. For instance, if there is severe weather approaching a part of town, such as a tornado or hurricane, the lighting control can broadcast instructions for the lights within a certain GPS-zone to change color or flash. Similarly, the lighting control can issue Amber Alerts via lighting signals to reach out to more individuals than can be accomplished by the internet, radio and/or television alone.

The GPS-based lighting system may further be used as a guide to lead ambulances, fire trucks, police vehicles, city maintenance crews, and the like to a specific place that help is needed. This is particularly important since many such vehicles do not include separate GPS devices and such vehicles may have difficulty finding obscure and unfamiliar locations.

Modifications, alterations, and combinations will occur to others upon reading and understanding the preceding detailed description. It is intended that the invention be construed as including all such modifications and alterations insofar as they come within the scope of the appended claims or the equivalents thereof.

What is claimed is:

1. A global positioning system (GPS) based lighting system comprising:
a plurality of lighting fixtures,
each lighting fixture including a light source, a sensor capable of detecting status of the fixture, and a microchip configured to detect the geographic location of said lighting fixture, and
said fixture being configured to broadcast a status and geographic location of the fixture to a remote lighting control system.

2. The GPS based lighting system of claim 1, wherein the lighting control system is configured to broadcast instructions to at least one lighting fixture based on geographic location.

3. The GPS based lighting system of claim 1, wherein the lighting control system is configured to broadcast instructions to the plurality of lighting fixtures.

4. The GPS based lighting system of claim 1, wherein the lighting control system is configured to perform wireless firmware updating of at least one lighting fixture.

5. The GPS based lighting system of claim 1, wherein the lighting control system is configured to notify maintenance personal of fixture status.

6. The GPS based lighting system of claim 5, wherein said lighting control system is configured to dispatch a maintenance vehicle in response to a fixture status showing a fault.

7. The GPS based lighting system of claim 5, wherein said at least one lighting fixture comprises a lighting fixture in which said sensor has detected a failure mode.

8. The GPS based lighting system of claim 5, wherein the lighting control system is configured to identify the fixture location on an electronic map and provide said location to the maintenance personnel.

9. The GPS based lighting system of claim 5, wherein the lighting control system is configured to provide the maintenance personnel with a suggested route to the at least one fixture.

10. The GPS based lighting system of claim 5, wherein the lighting control system is configured to provide the maintenance personnel with a listing of recommended spare parts to carry.

11. The GPS based lighting system of claim 1, wherein the lighting control system is configured to monitor and service the plurality of lighting fixtures.

12. The GPS based lighting system of claim 1, wherein the lighting control system is configured to determine theft of the lighting fixture.

13. The GPS based lighting system of claim 1, wherein the lighting control system is configured to monitor current and prior locations of each fixture.

14. The GPS based lighting system of claim 1, wherein said sensor is configured to detect at least one of whether said light source is on or off and if the fixture is functioning properly.

15. The GPS based lighting system of claim 14, wherein said sensor is configured to monitor at least one of current and voltage of the associated light source.

16. The GPS based lighting system of claim 1, wherein said sensor is configured to monitor the environment surrounding the fixture.

17. The GPS based lighting system of claim 1, wherein the fixture is assigned a security code.

18. The GPS based lighting system of claim 1, wherein each of the plurality of lighting fixtures is individually identifiable to the remote lighting control system by a GPS location, is individually in communication with the remote lighting control system, and individually receives fixture specific instructions from the remote lighting control system.

19. A global positioning system (GPS) based light fixture comprising:
a housing including a light source, a sensor capable of detecting status of the fixture, and a microchip configured to detect the geographic location of said lighting fixture, and
said fixture being configured to broadcast a status and geographical location of the fixture to a remote lighting control system.

20. A GPS based lighting system comprised of a plurality of lighting fixtures of claim 19 wherein each fixture communicates with the remote lighting control system and wherein said remote lighting control system is configured to selectively broadcast instructions to each fixture.

21. A method of controlling a plurality of (GPS) based lighting fixtures comprising:
providing a plurality of lighting fixtures,
each lighting fixture including a light source, a sensor capable of detecting status of the fixture, and a microchip configured to detect the geographic location of said lighting fixture, and
broadcasting a status and geographic location of the fixture to a remote lighting control system.

22. The method of claim 21, wherein said remote lighting control system broadcasts instructions to at least one of said light fixtures.

23. The method of claim 21, wherein said instructions comprise operating instructions.

24. The method of claim 23, wherein said operating instructions include a geographical location to which only lighting fixtures within said geographical location respond.

25. The method of claim 21, wherein said lighting control system automatically adjusts at least one lighting fixture.

26. The method of claim 21, wherein the lighting control system performs at least one of the functions selected from firmware updating, maintenance instructions, repair vehicle dispatch, mapping of fixture location, and identification of fixture theft.

27. A global positioning system (GPS) based lighting system comprising:
a plurality of lighting fixtures, each lighting fixture including a light source, a sensor capable of detecting status of the lighting fixture, and a microchip configured to detect and broadcast a geographic location of said lighting fixture, said lighting fixture operating without a media access control address, said lighting figure being configured to receive automated commissioning instructions from a remote control system, said commissioning instructions being selected for said lighting fixture based on the broadcast geographic location.
